(19) United States
(12) Patent Application Publication
(10) Pub. No.: US 2007/0252426 A1
(43) Pub. Date: Nov. 1, 2007

(54) Pellucid illuminating rims

(76) Inventor: Deddric C. Ridley, Couington, GA (US)

Correspondence Address: Deddric Ridley, 25 Appia Way, Covington, GA, 30014-8022, US

(21) Appl. No.: 11/412,890

(22) Filed: Apr. 28, 2006

(51) Int. Cl. B60B 3/10; B60B 5/02

(52) U.S. Cl. 301/63.101; 301/64.702

(57) ABSTRACT

The presented invention is directed generally to Pellucid Illuminating Rims. The presented invention is used for a new style for rims. The rims are designed for a newer look. They are made of glass, plastic and metal. The rims are transparent and illuminating. The rims can be stained and or tinted mostly any type of color in the rainbow. Around the rotor and around the inner part of the rim where the rim and the rotor attach; there will be a rotor switch, which will give the ability to illuminate. That will allow the neon light to be turned on or off inside of the vehicle. When the rotor switch is turned on and the vehicle is in motion; the rims will illuminate and spin in motion. These rims will come in different sizes: 14, 15, 16, 17, 18, 20, 22, 24 inches, with 4 or 5 lugs.

The presented invention is directed to generally to Pellucid Illuminating Rims. The presented invention is use for a new style for rims; they are made from glass, plastic and metal. The rims are designed for a newer look. The rims are transparent and illuminating (brighten). The rims can be stained and tinted mostly any type of color in the rainbow. Around the rotor or around the inner part of the rim, where the rim and the rotor attach; there will be a rotor switch witch will allow the neon light to be turned on off inside of the vehicle. When the rotor switch is turned on and the vehicle is in motion; the rims will illuminate and spin in motion. These rims will com in different sizes 14, 15, 16, 17, 18, 19, 20, 21, 22, 23, 24, 24, 25, 26, 27, and 28 inches, with 4, 5, or 6 lugs depending on how many lugs I will use.

Glass is one of the materials that would be used. The types of glasses that are used are Bullet-Resisting glass (Bullet Proof), Tempered Safety glass, Heat-Resistant glass, and the thick type of glass that hold up the glass for aquarium for big whales, sharks, and etcs . . .

Plastic is another material that would be used. The types of plastic are used are Melamine's, Phenolic's Epoxy's and Alkyl's. Those types of plastics are very hard and become strong; when mixed with substances such as finely ground wood, metallic compound, glass fibers, and asbestos. These substances are called fillers. When mixed with fillers, an epoxy compound becomes so hard and so strong that they can be used to make dies for shaping metal.

Metal is the last would be used. Metal will be used for the outer exterior of the rim, while glass of plastic is used in the interior of the rim.

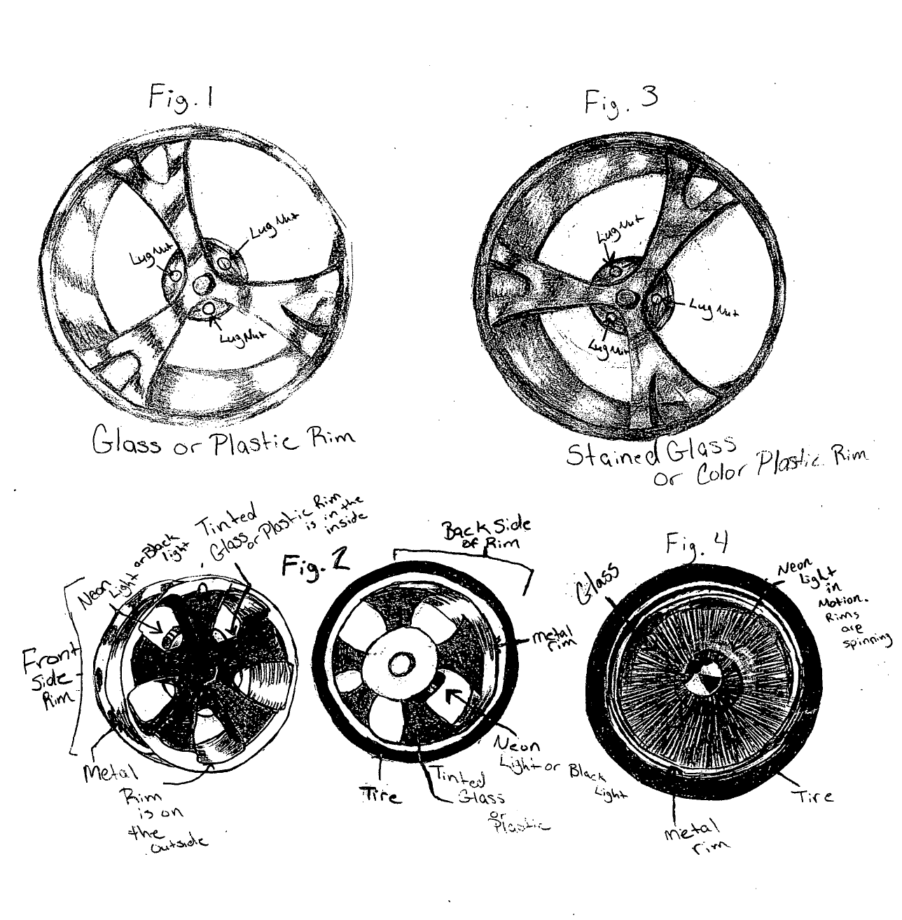

1. FIG. 1 show a picture of a glass or plastic rim, with lugs nuts.

2. FIG. 2 show a picture of a plastic and glass rim, with the rim tinted. It also shows a neon or black light on the rotor and its outer rims is metal.

3. FIG. 4 show the rim is in motion and the neon light is spinning. It shows the glass or plastic rims is in the inner part of the rim and the outer is metal.

The presented invention is directed to generally to Pellucid Illuminating Rims. The presented invention is use for a new style for rims; they are made from glass, plastic and metal. The rims are designed for a newer look. The rims are transparent and illuminating (brighten). The rims can be stained and tinted mostly any type of color in the rainbow. Around the rotor or around the inner part of the rim, where the rim and the rotor attach; there will be a rotor switch witch will allow the neon light to be turned on off inside of the vehicle. When the rotor switch is turned on and the vehicle is in motion; the rims will illuminate and spin in motion. These rims will corn in different sizes 14, 15, 16, 17, 18, 19, 20, 21, 22, 23, 24, 24, 25, 26, 27, and 28 inches, with 4, 5, or 6 lugs.

I claim:

1. Glasses that can hold a lot of pressure (weight), take a lot of speed, and take the weather; without breaking, scratching, or cracking the rim. The glasses are bullet-Resisting, Tempered Safety, and Heat-Resistant glasses.

2. A plastic that is very strong and hold a lot pressure, hold speed, and take the weather; without breaking, scratching, or cracking the rim. The plastics that would be used are melamines, phenolics, epoxies and alkyls.

3. An outer metal rims is around the inner glass or plastic rim for examples FIGS. 2 and 4.

4. Around the rim and the rotor; there will be a rotor switch. That will give the ability to illuminate.

5. Glass and plastic are stained any color of the rainbow
